(19) United States
(12) Patent Application Publication
(10) Pub. No.: US 2018/0184676 A1
(43) Pub. Date: Jul. 5, 2018

(54) NUT SHELL COATINGS FOR IMPROVED PROCESSING AND STORAGE

(71) Applicants: Richard Selinfreund, Las Cruces, NM (US); Robert Almond, Las Cruces, NM (US)

(72) Inventors: Richard Selinfreund, Las Cruces, NM (US); Robert Almond, Las Cruces, NM (US)

(21) Appl. No.: 15/738,403

(22) PCT Filed: Jun. 24, 2016
(86) PCT No.: PCT/US2016/039332

§ 371 Date: Dec. 20, 2017

Related U.S. Application Data
(60) Provisional application No. 62/184,175, filed on Jun. 24, 2015.

(51) Int. Cl. A23B 9/14; A23B 9/28

(52) U.S. Cl. CPC A23B 9/14; A23V 2002/00; A23B 9/28

(57) ABSTRACT

The present invention is directed to an integrated system of improving nut product safety, quality and production costs. Formulations and methods are provided for reducing pathogen contamination of nuts, improving storage stability of stored nuts and reducing refrigeration costs, and enhancing shelling operations by improving the contrast between nut shell fragments and nutmeats. The formulations may be used individually or in combination to provide all three commercial benefits of reduced bioburden, enhanced storage stability, and greater sorting efficiency of nutmeat from shell. The materials for the formulations disclosed herein are mostly derived from the waste materials of the species of tree that nut is harvested from and/or from other natural sources.

### CROSS-REFERENCE TO RELATED APPLICATION

This application claims the benefit of U.S. Provisional Application No. 62/184,175, filed Jun. 24, 2015.

### FIELD OF INVENTION

The present invention is directed to an advanced system of improving nut product safety, quality and production costs. Formulations and methods are provided for reducing pathogen contamination of nuts, improving storage stability of stored nuts and reducing refrigeration costs, and enhancing shelling operations by improving the contrast between nut shell fragments and nutmeats. By utilizing embodiments of the invention, the waste stream from the processing facility may be reduced.

### BACKGROUND

There is an integrated and emergent need for the nut industry to reduce pathogen contamination of nuts, to lower the costs of nut storage, and to increase the efficiency of nut shelling.

Contamination of the food supply by bacterial pathogens and the resultant food-borne illnesses are extensive national problems. According to the USFDA, in 2013, food-borne illnesses caused an estimated 48 million illnesses, and nearly 3,000 deaths in the United States. Because the symptoms are often flu-like, many people do not recognize that the illnesses are caused by harmful bacteria or other pathogens in their food.

Within the nut industry, there is a need to increasingly control and reduce pathogen contamination of nuts intended for human consumption. Raw tree nuts, such as walnuts, pecans, almonds and pistachios can be vehicles for foodborne pathogens, and have caused outbreaks of foodborne disease in the United States and elsewhere.

Salmonella and enterohemorrhagic Escherica coli (EHEC) are considered important causes of foodborne illnesses associated with the consumption of raw tree nuts. Even though low-moisture foods such as tree nuts are consumed in a dry state, and are conventionally believed to be of relatively low risk because they do not support bacterial growth, EHEC and Salmonella are found to cause illness even when present at very low levels of contamination in nuts. For illness to occur, bacterial growth, facilitated by moisture, need not occur. Only contamination is needed.

To the present, most outbreaks of foodborne illness from nuts have been associated with Salmonella. Over the past decade, salmonellosis linked to tree nuts has led to several product recalls. Contamination by Salmonella has been found, in almonds, cashews, pistachio, pine nuts, Brazil nuts, macadamia nuts and walnuts, among other types

There are likely many sources of Salmonella in tree nuts, but evidence suggests that a major source of contamination is the orchard itself. During harvesting there is significant mixing of the nuts with orchard soil and plant debris and contamination to the nuts occurs therefrom. Spreading of contamination can also occur during post-harvest processing of the nuts with, for example, from contacting the nuts with untreated water. Contamination can then be transferred from the nut shell to the edible kernel during shelling.

In some cases, tree nuts are microbiologically stabilized by drying. However, once dried and refrigerated, residual populations of Salmonella show exceptional survival, with little decrease of bacterial burden, for instance, after a year of storage.

To reduce pathogen burden a “microbial kill step” is usually utilized, typically accomplished by the application of bactericidal heat to the nuts to effect pasteurization before shelling. However, a validated heating process for one nut type cannot be universally applied to all tree nuts, as pathogens in various nuts respond differently to heat. A validated process for one nut type may not be suitable for another.

Thus, for health and economic reasons, there is a need for improved methods of controlling and reducing pathogen contamination of nuts, particularly contamination by Salmonella. There is also a need for an improved pathogen control material or process that is equally applicable to many nut types.

Additionally, there is a real commercial need to lower the cost of nutmeat storage as well as the storage of in-shell nuts before they are processed or shelled. As nuts may be stored for lengthy periods before processing and shelling, they become increasingly oxidized and rancid with time. The rate of oxidation of the nutmeat increases with storage temperature. As a result, it is generally advised to store the nut materials at freezing temperatures or otherwise refrigerate the nuts during storage, a costly process.

Fats and oils play an important role in the flavor, aroma, texture, and food quality of nuts. Nuts undergo a variety of chemical and physical changes as they are stored. Oxidation of lipids is a common and undesirable chemical change that occurs that negatively affects the food quality of nuts. The chemicals produced from oxidation of lipids are partly responsible for rancid flavors and aromas. Nuts are a food rich in polyunsaturated fatty acids (PUFAs), substances which are highly susceptible to oxidation. Nuts, therefore, are particularly susceptible to oxidation and oxidative rancidity.

Oxidation, rancidity and color change occur in part after atmospheric oxygen reacts with the fatty acids of the nutmeat to produce fatty acid hydroperoxides. Independently of storage temperature, oxygen is required for nutmeat oxidation. In the absence of oxygen, even when nuts are stored higher storage temperatures, oxidation, color change, and rancidity development will be very slow. It is therefore desirable, to prevent these changes, to limit the total exposure of the nutmeat to atmospheric oxygen anytime storage is needed.

Optical sorting is an automated process of sorting solid products using cameras and/or lasers. Optical scanners/sorters are used in the food, pharmaceutical, nutraceutical and water recycling industries. Optical sorters are in widespread use in the food industry worldwide, with the highest adoption in processing harvested foods such as potatoes, fruits, vegetables and nuts where it achieves non-destructive, 100 percent inspection in-line at full production volumes. Optical sorting is commonly used in the nut industry after shelling to separate nut shell fragments from the edible kernel or meat.

Many commercial food products are optically separated, including corn, rice, oats, sorghum and other grains. Seeds like sunflower, pumpkin, peony, pearl, barley, silymarin, rapeseed and castor bean can be optically sorted in large food production processing facilities. Many large nut shelling operations use optical sorting for acceptance/rejection criteria for pecans, walnuts, pine nuts, hazel nuts, macadamias, almonds, cashews, Brazil, cacao, chestnuts, peanuts, soy nuts during shelling operations.

Large nut shelling operations can process more than 100,000 lbs. of nuts in 24 hrs. By common standards, there is a requirement that no more than 1 shell piece in 250 lbs. of shelled nuts may be found. Many large shelling operations have invested in optical scanners/separators to remove shells from the meat. The “pinch point” at many shelling processors is the re-work of the final shelled product to reach the shell per shelled nut specification. Often the final product is “re-worked” 5 or 6 times through the optical scanning/separators. Re-work cycles through the optical scanners/separators and human inspection steps significantly slow down the shelling process.

Often the acceptance/rejection criteria frequently overlap at the edges of acceptability. The success of nut shell sorting depends on obtaining a good contrast between husk or shell and kernel. That is, optically distinguishing the shell from the nutmeat so that mechanical separation can occur.

Frequently, the scanner/separator cannot distinguish the shell from the nutmeat. The problem is twofold: 1) The optical quality of the shell can be very close to the optical quality of the nutmeat; 2) The natural variability of nut shells can make it very difficult to set the “band-width” or nutmeat selection optical band width for the scanner/separator.

Because of variability, some of the shell fragments fall into the optical band width of the nutmeat. It does not take very many shell fragments to ending up in the nutmeat to cause the final product to fall out of specification (e.g., 1 shell fragment/250 lbs. finished nuts) and require additional re-work cycles. Re-work often employs taking the final product through multiple scanner/separators steps and/or using humans to inspect the final product before packing. This causes a significant increase in capital expense or human capital to keep shelling operations in specification.

The present inventors have recognized that there needs to be a safer and more commercially effective way to further separate the acceptance and rejection criteria that does not impact the quality of the final product. They recognized the commercial benefit for developing a system or accessory processing product to reduce the number re-work cycles in nut processing. For example five re-work cycles reduced to one re-work cycle.

For effectiveness and acceptability, they recognized a product/process that has at least some of the following attributes, and preferably all, is desired: 1) The product/process cannot significantly deviate the current nut shelling process across the industry; 2) the product/process can must take advantage of one or more of the current nut shelling operation steps; 3) the product process should not deviate from approved processing steps by the Food and Drug Agency (USFDA); product/process improvement should be “clean label” and does not impact the quality of the nutmeat; 4) must increase the shell/nut optical contrast optimization so that the shell is more differentiated than the optical signature from the nut; 5) the process/product step must make the outside of the shell uniform and distinct from the nutmeat and therefore optical separators can always identify shell fragments; 6) reduces the cost of adding new or additional separators; 7) work with all existing optical scanner/separators and human inspection; 8) process improvement must be added to an existing step; 9) does not require constant monitoring; 10) has a long processing improvement half-life; (does not need to be added all the time); 11) product/processing step does not contaminate other steps in the nut manufacturing steps; 12) and, the processing aid should be easily removed and or recycled from waste stream before leaving the plant, ideally decreasing the overall waste stream coming from the nut processing plant.

To overcome the problems in separation, the present inventors propose adding a processing aid, such as described below, that enhances contrast between nut shell and nutmeat.

### SUMMARY OF INVENTION

The disclosed invention provides in embodiments formulations and methods for improving nut processing whereby the microbial burden of the nut and nutmeat is reduced, storage stability of the unshelled nut or nutmeat is enhanced, and shell contamination of the nutmeat after shelling is diminished. The disclosed formulations and methods may be used altogether or in any combination.

As bacterial pathogens such as Salmonella enterica are of severe concern to the nut processing industry, potentially causing food poisoning, in one embodiment the invention provides an outer nut shell coating or material that reduces Salmonella levels by multiple decades after application according to methods described herein.

Additionally, there is a real commercial need to lower the cost of storage of in-shell nuts before they are processed or shelled. One embodiment of the disclosed invention is an outer nut shell and/or nutmeat coating that reduces the requirement or cost to freeze or refrigerate the nuts before and after the shelling process. By reducing the exposure of the nutmeat to atmospheric oxygen, the coating reduces color change and rancidity development when the nuts are stored either at freezer temperatures, refrigerated temperatures or at ambient temperatures.

In an embodiment, the present inventors have employed a barrier that slows the diffusion of oxygen into the nutmeat thereby slowing oxidation and allowing higher storage temperatures. If applied to the shell, the barrier slows the diffusion of atmospheric oxygen into the nut through the shell and into the nutmeat; or, if applied to the nutmeat, through the barrier into the nutmeat. In one embodiment, the coating may be further function as an antibacterial agent. Such antibacterial coating may be favorably applied to the in-shell nuts before storage, in advance of processing and shelling.

By employing such outer nut shell and/or nutmeat coating, the requirement or cost to freeze or refrigerate the nuts before and after the shelling process may be reduced, as well as color changes and rancidity rates. Furthermore, when using such embodiment coating, even when the nuts are stored above normal refrigeration temperatures, the rate of oxidation may be further reduced compared to storage at the same temperature.

The present inventors have also noted that once the nuts are shelled, there is a real need to improve the sorting process which distinguishes between shell and nutmeat.

As known in the art, it is difficult for optical scanners to differentiate shell material from meat because of natural color variability of both the shell and nutmeat. The invention additionally provides in embodiments a nut shell coating or product processing product (PPP) that enhances the optical contrast between nut shell and meat, thereby allowing better optical discrimination for separating the shell or husk from the meat.

In embodiments of the current invention, the PPP comprises the natural husk material from the specific nut that is being processed. The present inventors have recognized that by employing such material to alter the concentration of such material in individual nuts, materials not found naturally in the nuts need not be added to the separation process. The natural husk material, however, may further be combined with a mordant which is FDA approved, to form an embodiment processing aid material. In preferred embodiments, the mordant is ferrous sulfate heptahydrate (iron (II) sulfate heptahydrate, FeSO₄.7H₂O, CAS Reg. No. 7782-63-0) and the nuts for processing, as examples, are pecan, walnut, macadamia and almond nuts.

In a particularly preferred embodiment, the PPP comprises a polyvalent metal ion, such as ferrous ion, Fe(II). In a particularly advantageous embodiment the ferrous ion is obtained from the compound FeSO₄ 7.H₂O (ferrous sulfate heptahydrate). In a particularly preferred embodiment, the PPP contains the compound nut husk material in conjunction with ferrous sulfate heptahydrate in the ratio of about 1:7 by weight.

In an embodiment of the invention, the PPP is added to the current “microbial kill” step used by nut processing facilities. In embodiments, the PPP may be added directly to microbial kill water bath typically at the temperature, about 190° F., used by many shelling operations. The PPP is used at weight/volume ratio of about 1.0 gram/liter of kill bath water. In another embodiment the nuts in the shells can be sterilized by heating in an oven and the PPP can be added to the nuts before or after oven sterilization by dipping in water based solution or spray applied to the nuts before or after sterilization.

Further embodiments disclosed include an antimicrobial composition for coating nuts comprising Yucca extract concentrate, methyl cellulose, walnut shell powder and walnut ink. A particularly advantageous antimicrobial composition for coating nuts of such composition comprises Yucca extract concentrate, methyl cellulose, walnut shell powder and walnut ink, comprising 1-5% Yucca extract concentrate@40% Brix. In another such embodiment, the antimicrobial composition of comprises, per 100 ml mixture, 5% Yucca extract concentrate@40% Brix, 4 g methyl cellulose, 16 g of ground walnut shell powder, and 3.2 ml of walnut ink.

In further embodiments is disclosed an aqueous antioxidant barrier coating for nuts comprising carboxymethyl cellulose at a concentration of about 0.5% to about 3%, propylene glycol at a concentration of about 0.5% to about 3%, sodium gluconate at a concentration of about 0.001% to about 0.5%, sorbitol at a concentration of about 0.1% to about 1%, lecithin at a concentration of about 0.05% to about 1%, and alpha tocopherol at a concentration of about 0.01% to about 1%.

In a particular advantageous embodiments an aqueous antioxidant barrier coating for nuts comprises carboxymethyl cellulose in a concentration of about 2.0%, the propylene glycol in a concentration of about 3.0%, the concentration of sodium gluconate is about 0.1%, the concentration of sorbitol is about 0.5%, the concentration of lecithin is about 0.2%, and the concentration of alpha tocopherol is about 0.5%.

In further embodiments is disclosed a shelling processing aid (PPP) for improving the optical contrast between nutshells and nutmeats comprising material derived from the nut husks of the nuts to be processed and a polyvalent metal ion containing compound.

In further embodiments is disclosed a shelling processing aid for improving the optical contrast between nutshells and nutmeats comprising material, which optimally is detectable by optical scanners, derived from the nut husks of the nuts to be processed and a polyvalent metal ion containing compound, wherein the nut husks are selected from the group comprising pecan husks, walnut husks, macadamia nut husks and almond nut husks.

In further embodiments is disclosed a shelling processing aid for improving the optical contrast between nutshells and nutmeats comprising material, which optimally is detectable by optical scanners, derived from the nut husks of the nuts to be processed and a polyvalent metal ion containing compound, wherein the nut husks are pecan husks.

In further embodiments is disclosed a shelling processing aid for improving the optical contrast between nutshells and nutmeats comprising material, which optimally is detectable by optical scanners, derived from the nut husks of the nuts to be processed and a polyvalent metal ion containing compound, wherein the nut husks are pecan husks, and wherein the polyvalent metal ion containing compound is an iron polyvalent metal ion.

In further embodiments is disclosed a shelling processing aid for improving the optical contrast between nutshells and nutmeats comprising material derived from the nut husks of the nuts to be processed which optimally is detectable by optical scanners, and a polyvalent metal ion containing compound, wherein the nut husks are pecan husks, wherein the polyvalent metal ion containing compound is an iron polyvalent metal ion, wherein the polyvalent metal ion containing compound is an iron(II) polyvalent metal ion.

In further embodiments is disclosed a shelling processing aid for improving the optical contrast between nutshells and nutmeats comprising material derived from the nut husks of the nuts to be processed which optimally is detectable by optical scanners, and a polyvalent metal ion containing compound, wherein the nut husks are pecan husks, and wherein the polyvalent metal ion containing compound is iron(II) sulfate heptahydrate.

In further embodiments is disclosed a shelling processing aid for improving the optical contrast between nutshells and nutmeats comprising materials derived from pecan nut husks, which optimally are detectable by optical scanners, and iron(II) sulfate heptahydrate, wherein the pecan husk material and iron(II) sulfate heptahydrate are in a mass ratio of about 1:2 to about 1:10.

In further embodiments is disclosed a shelling processing aid for improving the optical contrast between nutshells and nutmeats comprising materials derived from pecan nut husks, which optimally are detectable by optical scanners, and iron(II) sulfate heptahydrate, wherein the pecan husk material and iron(II) sulfate heptahydrate are in a mass ratio of about 1:7.

In further embodiments is disclosed a shelling processing aid for improving the optical contrast between nutshells and nutmeats comprises materials derived from pecan nut husks, which optimally are detectable by optical scanners, and iron(II) sulfate heptahydrate, wherein the pecan husk material and iron(II) sulfate heptahydrate are in a mass ratio of about 1:7, and wherein the shelling processing aid is added to water at a concentration of about 1 g/liter, forming a working solution for contrast improvement for pecans.

In further embodiments is disclosed an integrated process for improving the product quality of pecan nuts, comprising the steps of i) coating the nuts with an anti-salmonella composition comprising about 5% Yucca extract concentrate@40 Brix, about 5 g methyl cellulose, about 15.9 g of ground walnut shell powder, and about 3.2 ml of walnut ink (all per 100 ml solution), ii) further coating the nuts with the shelling processing aid comprising materials from pecan husks and iron(II) sulfate heptahydrate combined in a mass ratio of about 1:7, iii) subsequently coating the nuts with an anti-rancidity formula comprising carboxymethyl cellulose at a concentration of about 0.5% to about 3.0%, propylene glycol at a concentration of about 0.5% to about 3.0%, sodium gluconate at a concentration of about 0.001% to about 0.5%, sorbitol at a concentration of about 0.1% to about 1%, lecithin at a concentration of about 0.05% to about 1% and alpha tocopherol at a concentration of about 0.01% to about 1%, iv) storing the nuts, v), pasteurizing the nuts, and vi), shelling and optically sorting the nuts to separate nutshell from nutmeat.

The formulations disclosed herein as exemplary can be used individually or in combination to provide all three commercial benefits of reduced bioburden, enhanced storage stability, and greater sorting efficiency of nutmeat from shell.

The materials for the formulations disclosed herein are mostly derived from the waste materials of the species of tree that nut is harvested from and/or from other natural sources. As such, these compositions and methods provide a significant advance in the state of the art over previously disclosed formulations.

### BRIEF DESCRIPTION OF FIGURES

FIG. 1 depicts the contrast and color values determined by a commercial scanner/color meter as a function of dose, obtained by treating pecan nuts with the product processing product (PPP) of the invention. Unbroken line, light to dark value, “L” (white=100, black=0); dashed line, blue color to yellow color value; broken dashed line, green color to red color value.

FIG. 2 depicts a PPP recycling system for removing the processing product from the waste stream following nut treatment with PPP.

The present invention will now be more fully described with reference to the accompanying examples. It should be understood, however, that the following description is illustrative only and should not be taken in any way as a restriction on the generality of the invention specified above.

### DETAILED DESCRIPTION OF PREFERRED EMBODIMENTS

As described, herein, bacterial pathogens that are of relevance to the invention are those associated with foodborne illness, generally, including but not limited to Campylobacter jejuni, Clostridlum botulinum, Clostridium perfringens, Cryptosporidium, enterohemorrhagic Escherica coli (including Escheria coli O157:H7), Listeria monocytogenes, Salmonella and its multiple types, Shigella and its multiple types, Staphylococcus aureus and Vibrio vulnificus. Pathogens that are of particular relevance to nut processing industry are recognized to be Salmonella and its multiple types and enterohemorrhagic Escherica coli.

As used herein, Yucca Extract or Yucca Extract Concentrate is the natural extract of the Mohave Yucca Plant (Yucca schidegera). In a preferred embodiment, the concentration is 40 Brix. Mohave Yucca (Yucca schidigera) is approved for use in food and beverages by the FDA under CFR 172.510, FEMA number 3121 and allowed for use in organic production without preservatives under 7 U.S.C 605 and N.O.P. 205.602. Yucca Extract is exempt from the requirement of a tolerance as specified in 40 CFR 180.100.

Antioxidants generally are substances that prevent or inhibit the oxidation of susceptible substances either by direct chemical interaction or by functioning to prevent the exposure of the other substance to oxygen. As used herein, an antioxidant is a substance that inhibits oxidation, especially one used to counteract the deterioration of stored nut stuffs, either by direct chemical action or as a physical barrier to oxygen diffusion. Many synthetic antioxidants such as propyl gallate, tertiarybutylhydroquinone, butylated hydroxyl anisole and butylated hydroxytoluene and others are well known to the artisan and are considered within the scope of the invention. However, natural, non-synthetic antioxidants such as Vitamin C (ascorbic acid) and alpha-tocopherol and related tocopherols are preferred examples of antioxidants useful for the invention. Fat soluble antioxidants such as alpha tocopherol function to prevent rancidity by preferentially reacting with oxygen free radicals, thereby inhibiting the oxidation of fatty substances in the food or nut.

GRAS compounds are preferred compounds for use with the invention. “GRAS” is an acronym for the phrase “Generally Recognized As Safe.” Under sections 201(s) and 409 of the Federal Food, Drug, and Cosmetic Act, any substance that is intentionally added to food is a food additive, that is subject to premarket review and approval by FDA, unless the substance is generally recognized, among qualified experts, as having been adequately shown to be safe under the conditions of its intended use, or unless the use of the substance is otherwise excluded from the definition of a food additive.

Under sections 201(s) and 409 of the Act, and FDA's implementing regulations in 21 CFR 170.3 and 21 CFR 170.30, the use of a food substance may be GRAS either through scientific procedures or, for a substance used in food before 1958, through experience based on common use in food.

Without limitation, all agriculturally useful nuts, such as pecans, walnuts, pine nuts, hazel nuts, macadamias, almonds, cashews, Brazil, cacao, chestnuts, peanuts, and soy nuts are within the scope of the invention.

### Anti-Microbial Shell Coating

In one embodiment of the invention a coating composition effective for reducing the surface burden of Salmonella of walnuts is disclosed and other nuts. The composition comprises Yucca extract, methyl cellulose, walnut shell powder and walnut ink.

### Example 1

The coating of Table 1 is prepared and applied to nut shells by dipping or other means. The amounts listed are in water, per 100 ml total volume.

TABLE 1
Exemplary Composition Antimicrobial Coating per 100 ml Water

a) 5 ml Yucca Extract Concentrate @ 40% Brix
b) 4.0 g methyl cellulose
c) 15.9 gram of ground walnut shell powder, WF-7 #325.
d.) 3.2 ml walnut ink.

Walnut ink is available from Shellac.net Wood Finish Supply, 2325 #A, First Street, Napa, Calif. 94559. Walnut powder (WF-7 #325) is available from Composition Materials Co., Inc., 249 Pepes Farm Road, Milford, Conn. 06460.

According to the invention, the composition is useful over a concentration range of about 0.5% to about 5% yucca extract concentrate @ 40% Brix.

According to the invention, the nuts are dipped into the coating of Table 1 and dried at 40° C. for 1 hour. Alternatively, the nuts may be rapidly dried in a heating tunnel. When tested for Salmonella, a 2 decade reduction (1/100) of Salmonella levels may be obtained.

Before cracking, the nuts may be washed in running water for 45 seconds to remove the coating. A five decade reduction (1/100,000) in salmonella level may be achieved thereby.

As the antimicrobial composition is expected to act directly on the pathogenic organism, and not to be significantly affected by the nut surface, it is expected that the disclosed composition will have utility for other nut types and pathogens other than Salmonella.

### Anti-Oxidant Barrier Coating

A barrier coating for inhibiting the rancidity of nuts or nutmeats is another embodiment of the invention. It is supposed that the barrier coat of the invention decreases rancidity by providing a barrier against oxygen diffusion through the nut shell into the nutmeat, or if the nutmeat is coated, into the nutmeat. The composition is expected to decrease the need for refrigeration, that to slow the development of rancidity when nuts are stored at higher temperatures.

The coating composition comprises the following components, useful in the ranges given, based upon weight/volume (g/100 ml) fraction in water: carboxymethyl cellulose, from about 0.5% to about 3.0%; propylene glycol, from about 3% to about 5%; sodium gluconate, from about 0.001% to 0.5%; sorbitol, from about 0.1% to about 1%; lecithin from about 0.05% to 1%; and alpha tocopherol, from about 0.01% to 1%.

### Example 2

A preferred, exemplary composition of the antioxidant coating is shown in Table 2.

TABLE 2

| | Concentration (wt %) | |
|---|---|---|
| Component | in water | Function |
| carboxymethyl cellulose | 2.0% | oxygen barrier |
| propylene glycol | 3.0% | edible plasticizer |
| sodium gluconate | 0.1% | natural chelator |
| sorbitol | 0.5% | edible plasticizer |
| lecithin | 0.2% | surfactant, |
| | | emulsifier |
| alpha-tocopherol | 0.5% | antioxidant |

The exemplary formula comprises sodium gluconate, a natural chelator of metal ions. Sodium gluconate assists in preventing rancidity, instead of, for example, EDTA, a synthetic compound.

The composition is prepared by mixing the carboxymethyl cellulose in hot water at 100° C. to make a 10% wt % solution, which is diluted into cold water. Sodium gluconate and sorbitol are next added with stirring. Lecithin and alpha tocopherol are added last. Water in sufficient quantity is added to the mixture to bring the composition to the final concentrations.

The mixture may be de-aerated under vacuum at 20 mm Hg to remove entrapped bubbles. The coating solution is best stored at 4° C.

The mixture may be applied to the nuts by spraying or dipping or by other means known to the artisan.

### Product Processing Product (PPP) Contrast Aid

In another embodiment of the invention, herein is disclosed a new processing aid mixture (Product Processing Product, “PPP”, or alternatively, “shelling processing aid”) comprising natural husk material and an FDA-approved processing aid for the improved optical separation of the shells (husks) of seeds and nuts from their respective meats. Surprisingly, the invention meets most, if not all of the criteria listed above in [0022] for improving shelling operations by optical sorting.

Upon treatment of the nuts with the processing aid mixture, the PPP improves the optical contrast between husk shell and meat and allows more efficient optical sorting between husk and meat.

The PPP comprises materials from recycled nut husks and one or more polyvalent metal cations. It is theorized that the polyvalent metal cations act as mordants. In the prior art, a polyvalent metal ion, such as ferrous ion, is often used to attach a dye to a product or material. A polyvalent metal ion or mordant forms a coordination complex between a coloring agent and the product that takes up the color. Additionally, a mordant can intensify a colors from husks derived from natural products like husks, and other natural products.

In one preferred embodiment of the invention, the PPP may be added to the “microbial kill step” tank which is routinely used in nut processing operations.

In one preferred embodiment the PPP comprises the natural husk material (0.4 Kg) from the specific nut that is being processed, combined with a FDA-approved processing aid (2.9 Kg) material comprising a polyvalent metal cation.

In one embodiment, the FDA-approved processing aid is ferrous ion, obtained from ferrous sulfate heptahydrate, FeSO₄.7H₂O, CAS Reg. No. 7782-63-0. The amount of processing aid may be modified depending on identity, mass and charge of the polyvalent ion mordant. In other preferred embodiments, the nuts for processing with the PPP are pecan, walnut, macadamia and almond nuts.

Other examples of mordant compounds useful for the invention are potassium aluminum sulfate K(Al)(SO₄)₂, potassium aluminum sulfate dodecahydrate, K(Al)(SO₄)₂.12(H₂O), and stannous chloride, SnCl₂,

In another embodiment the nuts in the shells can be sterilized by heating in an oven and the PPP can be added to the nuts before or after oven sterilization by dipping in water based solution or spray applied to the nuts before or after sterilization.

In the PPP, a ratio of husk material to polyvalent cation compound of about 1:7 is preferred. In a preferred embodiment, PPP is added directly to microbial kill water bath, typically at 190° F., a temperature used in many shelling operations.

In one embodiment, about 14.4 Kg of processing aid mixture is added to about 5,000 gallons of water (at ratio of about 0.8-1.1 grams/liter of water).

In accordance with 21 CFR 184.1(b)(1), the ingredients of the present invention are used in food as nutrient supplements as defined in 21 CFR 170.3(o)(20) of that chapter and as a processing aid as defined in 21 CFR 170.3(o)(24), with no limitation other than usage under current good manufacturing practices. The natural husk mixture used in the processing aid is “waste” product from the specific species from the nut material tree or stalk from which the nut is removed and therefore is a natural product and contains natural materials.

Ferrous sulfate is an affirmed GRAS compound (21 CFR § 184.1315 Ferrous sulfate).

In a preferred embodiment the nut husk material is 1× (0.4 Kg) husk material to (2.9 Kg) processing aid and the processing aid is ferrous sulfate heptahydrate (iron (II) sulfate heptahydrate, FeSO₄.7H₂O. The composition is diluted to a preferred concentration of 1.0 grams per 1 liter of water.

Examples of polyvalent cations which may be useful for the invention are shown below in Table 3:

TABLE 3

| | | |
|---|---|---|
| Aluminum | Al³⁺ | |
| Barium | Ba²⁺ | |
| Calcium | Ca²⁺ | |
| Copper(II) | Cu²⁺ | Cupric |
| Iron(II) | Fe²⁺ | Ferrous |
| Iron(III) | Fe³⁺ | Ferric |
| Magnesium(II) | Mg²⁺ | |
| Manganese(II) | Mn²⁺ | Manganous |
| Tin(II) | Sn²⁺ | Stannous |
| Tin(IV) | Sn⁴⁺ | Stannic |
| Zinc | Zn²⁺ | |

### Example 3

In a preferred embodiment the nut husk material is in the amount of 0.4 Kg husk material to 2.9 Kg processing aid, and the processing aid is ferrous sulfate heptahydrate (iron (II) sulfate heptahydrate, FeSO₄.7H₂O. The composition is diluted to a preferred concentration of 1.0 gram per 1 liter of water (1× concentration), a mixture into which the nuts are placed for testing contrast development.

When this embodiment is used as a processing aid, as shown in Table 4 below, this mixture produces an average light to dark value (L=100, white; L=0, black) on the nut of L=32 with a standard deviation of 1.59 (obtained with a Hunter Instruments, Model Ultrascan/Vis EasyMatch Software Reston, Va.). Lower L values correspond to greater contrast, which is desired. Increasing the concentration 3×, 10× does not significantly improve the dark values (giving L=35 and 32 respectively). Therefore, increasing the concentration above 1× does significantly improve the dark value on the nut. Alternatively, decreasing the concentration of PPP degrades the dark value on the nut. Concentrations of (0.33×) and 0.1× result in dark values increasing to 37 and 40 respectively. No good processing products have L (dark values) of 40.

Additionally, the standard deviation of the 0.33×, 0.1× and no processing product (0×), is significantly higher than 1× concentrations. Developing a consistent shell processing L value allows for the scanner/separator to be set to exclude shell parts.

TABLE 4
Processing Product

| | Shell 1 | | | Shell 2 | | | Shell 3 | | |
|---|---|---|---|---|---|---|---|---|---|
| | L* | a* | b* | L* | a* | b* | L* | a* | b* |
| Water 1 | | | | | | | | | |
| | 41.62 | 11.26 | 16.83 | 44.31 | 8.57 | 15.74 | 40.93 | 9.06 | 15.08 |
| 2 | 42.13 | 9.66 | 15.97 | 39.36 | 10.28 | 15.83 | 40.25 | 10.93 | 16.56 |
| 3 | 41.07 | 9.52 | 16.64 | 39.53 | 5.27 | 9.65 | 37.38 | 6.31 | 10.88 |
| 4 | 39.12 | 11.49 | 16.83 | 36.78 | 11.38 | 14.46 | 38.29 | 11.46 | 16.14 |
| 5 | 39.72 | 11.87 | 17.6 | 34.44 | 7.28 | 11.88 | 42.24 | 10.81 | 17.45 |
| 6 | 41.87 | 8.02 | 14.61 | 40.29 | 8.02 | 14.41 | 42.33 | 8.97 | 14.99 |
| Avg | 40.09 | 9.45 | 15.09 | | | | | | |
| St Dev | 2.35 | 1.93 | 2.22 | | | | | | |
| 1/10× 1 | | | | | | | | | |
| | 38.39 | 7.84 | 14.03 | 39.55 | 9.28 | 14.27 | 38.18 | 9.74 | 15.59 |
| 2 | 40.94 | 10.58 | 16.15 | 36.21 | 8.95 | 14.14 | 43.52 | 11.39 | 18.71 |
| 3 | 45.39 | 12.25 | 20.04 | 40.13 | 7.86 | 13.78 | 42.1 | 10.72 | 16.52 |
| Avg | 40.49 | 9.85 | 15.91 | | | | | | |
| St Dev | 2.69 | 1.44 | 2.09 | | | | | | |
| ⅓× 1 | | | | | | | | | |
| | 32.58 | 5.63 | 8.86 | 39.16 | 9.67 | 14.56 | 33.81 | 5.49 | 9.48 |
| 2 | 37.3 | 9.39 | 14.3 | 41.79 | 8.95 | 14.63 | 39.62 | 9.54 | 14.9 |
| 3 | 38.5 | 10.37 | 15.28 | 36.92 | 9.24 | 13.15 | 35.36 | 6.57 | 9.75 |
| Avg | 37.23 | 8.32 | 12.77 | | | | | | |
| St Dev | 2.76 | 1.77 | 2.48 | | | | | | |
| 1× 1 | | | | | | | | | |
| | 29.66 | 1.19 | 4.66 | 32.12 | 1.03 | 6.41 | 29.1 | 0.68 | 4.55 |
| 2 | 31.96 | 0.88 | 6.77 | 31.53 | 2.61 | 8.55 | 32.32 | 0.51 | 5.45 |
| 3 | 33.24 | 1.43 | 7.07 | 34.39 | 1.13 | 6.77 | 33.1 | 1.78 | 7.68 |
| Avg | 31.94 | 1.25 | 6.43 | | | | | | |
| St Dev | 1.59 | 0.60 | 1.26 | | | | | | |
| 3× 1 | | | | | | | | | |
| | 32.62 | 2.16 | 8.69 | 34.05 | 1.54 | 7.43 | 30.66 | 1.27 | 7.5 |
| 2 | 33.2 | 0.78 | 6.03 | 35.65 | 2.56 | 10.81 | 35.05 | 1.3 | 8.1 |
| 3 | 38.23 | 2.45 | 9.35 | 37.11 | 1.57 | 6.81 | 36.89 | 1.77 | 8.21 |
| Avg | 34.83 | 1.71 | 8.11 | | | | | | |
| St Dev | 2.29 | 0.55 | 1.33 | | | | | | |
| 10× 1 | | | | | | | | | |
| | 34.54 | 1.75 | 7.41 | 31.31 | 0.54 | 4.77 | 28.55 | 1.26 | 5.05 |
| 2 | 31.06 | 1.07 | 5.6 | 31.16 | 0.89 | 5.84 | 29.14 | 1.11 | 5.57 |
| 3 | 35.39 | 1.44 | 7.16 | 35.05 | 1.66 | 7.03 | 31.12 | 1.01 | 6.26 |
| Avg | 31.92 | 1.19 | 6.08 | | | | | | |
| St Dev | 2.36 | 0.36 | 0.89 | | | | | | |

| | | Averages | | |
|---|---|---|---|---|
| | | Color | | |
| | [PPP] | L* | a* | b* |
| Concentration | 0 | 40 | 9 | 15 |
| | 0.1× | 40 | 10 | 16 |
| | 0.33× | 37 | 8 | 13 |
| | 1× | 32 | 1 | 6 |
| | 3× | 35 | 2 | 8 |
| | 10× | 32 | 1 | 6 |

L* = Light to Dark value (White = 100, Black = 0)
a* = Green to Red Value
b* = Blue to Yellow Value

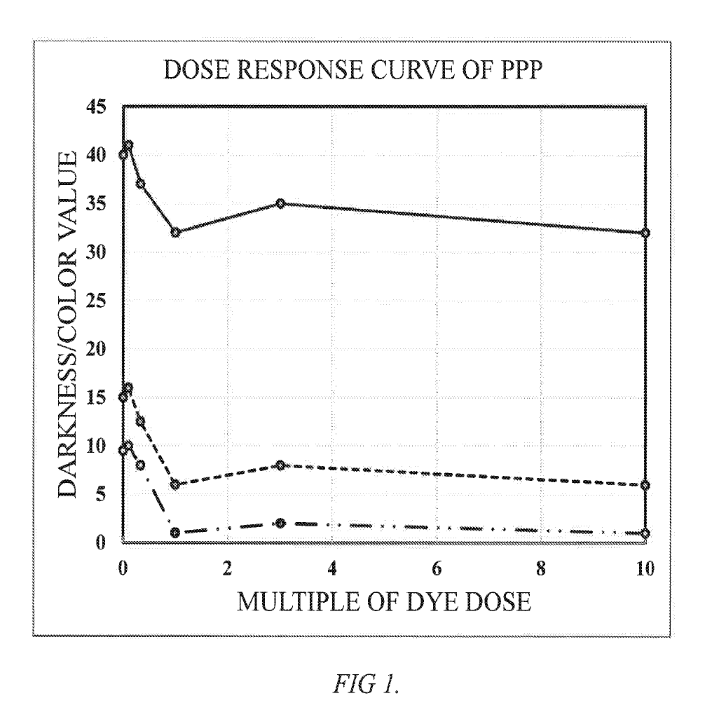

The average L value for each concentration of processing aid is graphed in FIG. 1 (PPP Dose Response Curve).

Another example of existing optical equipment that may be used for optical sorting is the Scan Master II (Satake), SMII DE/XE 800/400/200 Series color sorting machinery.

### Example 4

A working batch of PPP was prepared and used to colorize pecan nutshells in a pasteurization tank in advance of sorting. Thereby 100 lbs. (45.3 kg) of ferrous sulfate heptahydrate and 6.355 kg of ground pecan husk containing 14% moisture were mixed for 10 minutes in a rotating mixer. The working batch of PPP was divided into containers, each container holding 3.255 kg of PPP.

Four containers (13.02 kg) of PPP was placed into 11,420 liters (L) of water to charge the system to give a concentration of 1.1 g/L. The water was heated to 190° F. to obtain pasteurization temperatures. 300 pounds of pecans were placed in the pasteurization tank every 10 minutes. The pasteurization tank was refreshed with two containers of PPP every 3 hours to maintain the concentration of PPP in the tank.

The optical darkness, L, of the nuts obtained thereby was approximately 30 L as measured by the Hunter instrument (Hunter Instruments, Model Ultrascan/Vis, EasyMatch Software Reston, Va.). Pecans or nuts without the PPP treatment have an L value of 40-50 L.

In preferred embodiments of the invention the nuts used with PPP are: pecans, walnuts, almonds, and macadamia nuts.

Pasteurization, sterilization processes for nuts include: steam (water bath in the preferred embodiment we added the PPP to the water bath at temperatures above 184° F., preferably between 190° and 194° F.). A time longer than 7 minutes is used to kill salmonella. However, in the current invention a time between 9-14 minutes was used in the water bath to coat the shells with PPP.

It is envisioned that the PPP mixture will enhance the microbial effectiveness of the “kill step” when added at this stage. One mechanism for this activity would be redox cycling of the polyvalent transition metal producing toxic oxygen radicals.

Sterilization processes can also include oil bath emersion of the nuts in the shell or dry. In another embodiment the oily husks of the plant material are extracted in oil and the nuts are passed through the oil bath containing the oil and the extracted husk material.

In another embodiment, the nuts in the shells can be sterilized by heating in an oven and the PPP can be added to the nuts after before oven sterilization by dipping in water based solution or spray applied to the nuts before or after sterilization.

In other embodiments, the processing aid may be sprayed on the nuts during dry roasting. In other embodiments of the invention, the processing aid mixture may be sprayed on the nuts during dry sterilization. In yet other embodiments of the invention, the processing aid mixture may be part of an oil or oil in water mixture.

### Example 5

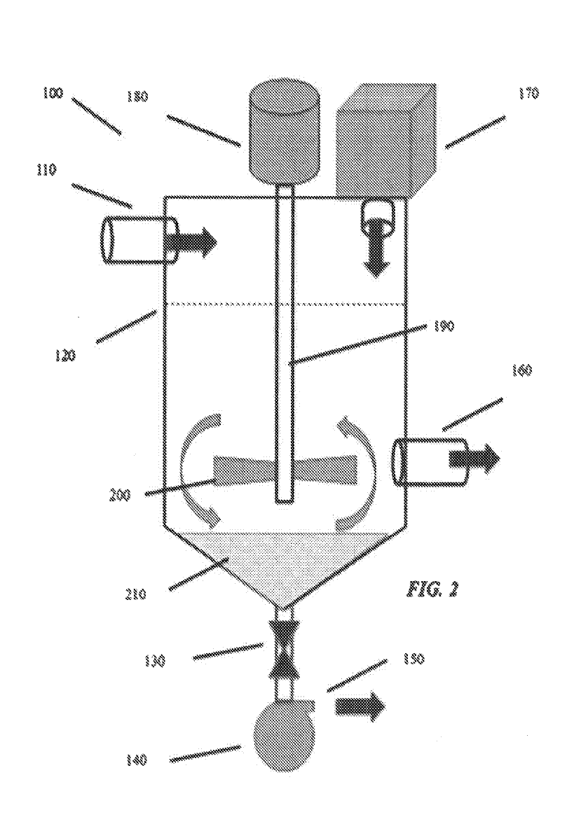

In a preferred embodiment of the invention, the processing aid mixture can be removed from the waste stream from the heat kill step along with other waste products by forming pH dependents in the waste stream. (FIG. 2, PPP Recycling Pump.) This improves the water quality of the waste stream. Using jar testing, it was determined that adding base to the waste water product from the heat kill step tank induces a pH dependent precipitate.

Referring to FIG. 2, which discloses schematically a recycling pump system 100 for removing the processing aid mixture from the waste stream, port 110 allows entry of the waste stream from the pasteurization tank into the recycling pump system 100, filled to liquid level 120. Motor 180 provides stirring of the liquid contents of the system via connected shaft 190 connected to impeller 200. Flocculating agent and flocculating agent aid may be delivered to the tank by dispenser 170. Cleaned effluent exits the system via outflow port 160. Flocculent precipitate and sludge 210 are removed as needed from the system via valve 130 and sludge pump 140. Sludge waste 210 is collected at port 150 and disposed as required.

The precipitation effect is pH dependent. Acidic pH does not induce precipitate formation. The amount of precipitate from the waste water treated with acid and base starting at pH 2.0 and ending at pH 13.0 was tested. The pH between 2.0 to 9.0 did not cause precipitation formation. However, pH values higher than 10 and especially a pH range between 11 and 13 induced a rapid precipitation of materials in the waste water. Thus, this precipitate method pulls down additional products from the waste stream.

On a large scale, lime or slaked lime could be added to the mixing tank shown in FIG. 2 and the resultant precipitate removed as sludge waste.

One advantage of this precipitation step is that it increases the quality of the water being pumped out of the microbial/kill waste water for large volume processing operations.

Different sources of water need different coagulants, but the most commonly used coagulants are alum and ferric sulfate:

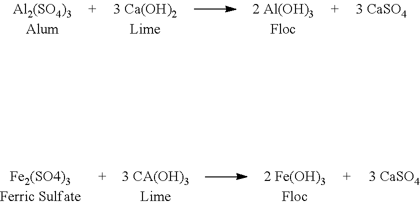

The following coagulant and coagulant aids, shown in Table 5, are useful in embodiments of the invention.

TABLE 5

| | | Primary | Coagulant |
|---|---|---|---|
| Chemical Name | Chemical Formula | Coagulant | Aid |
| Aluminum sulfate (Alum) | Al₂(SO₄)₃•14H₂O | X | |
| Ferrous sulfate | FeSO₄•7H₂O | X | |
| Ferric sulfate | Fe₂(SO₄)₃•9H₂O | X | |
| Ferric chloride | FeCl₃•6H₂O | X | |
| Cationic polymer | Various | X | X |
| Calcium hydroxide (Lime) | Ca(OH)₂ | X | X |
| Calcium oxide | CaO | X | X |
| (Quicklime) | | | |
| Sodium aluminate | Na₂Al₂O₄ | X | X |
| Bentonite | Clay | | X |
| Calcium carbonate | CaCO₃ | | X |
| Sodium silicate | Na₂SiO₃ | | X |
| Anionic polymer | Various | | X |
| Nonionic polymer | Various | | X |

In accordance with 21 CFR 184.1(b)(1), the ingredients of the embodiment are used in food as nutrient supplements as defined in 21 CFR 170.3(o)(20) and are processing aids as defined in 21 CFR 170.3(o)(24), with no limitation other than current good manufacturing practices. The natural husk mixture is “waste” product from the specific species from the nut material tree or stalk from which the nut is removed and therefore is a natural product and contains natural materials.

### Integrated Processing of Nuts

In an embodiment of the invention, an integrated method for improving nut processing whereby the microbial burden of the nut and nutmeat is reduced, storage stability of the unshelled nut is enhanced, and shell contamination of the nutmeat after shelling is diminished is envisioned. The integrated process comprises the steps of i) coating the nuts with the anti-salmonella composition of Example 1, ii) further coating the nuts with the PPP of Example 3, iii) subsequently coating the nuts with the anti-rancidity of formula of Example 2, iv) storing the nuts as needed, v), pasteurizing the nuts, and vi) shelling and optically sorting the nuts to separate nutshell from nutmeat.

Many other variations of the present invention will be apparent to those skilled in the art and are meant to be within the scope of the claims appended hereto.

We claim:

1. An antimicrobial composition for coating nuts comprising Yucca extract, methyl cellulose, walnut shell powder and walnut ink.

2. The antimicrobial composition of claim 1 comprising 1-5% Yucca extract concentrate@40% Brix.

3. The antimicrobial composition of claim 2 comprising about 5% Yucca extract concentrate@40% Brix, about 4 g methyl cellulose, about 15.9 g of ground walnut shell powder, and about 3.2 ml of walnut ink per 100 ml aqueous solution.

4. An aqueous antioxidant barrier coating for nuts comprising carboxymethyl cellulose at a concentration of about 0.5% to about 3.0%, propylene glycol at a concentration of about 0.5% to about 3.0%, sodium gluconate at a concentration of about 0.001% to about 0.5%, sorbitol at a concentration of about 0.1% to about 1%, lecithin at a concentration of about 0.05% to about 1% and alpha tocopherol at a concentration of about 0.01% to about 1%.

5. The aqueous antioxidant barrier coating of claim 4 wherein the concentration of carboxymethyl cellulose is about 2.0%, the concentration of propylene glycol is about 3.0%, the concentration of sodium gluconate is about 0.1%, the concentration of sorbitol is about 0.5%, the concentration of lecithin is about 0.2%, and the concentration of alpha tocopherol is about 0.5%.

6. A shelling processing aid for improving the optical contrast between nutshells and nutmeats comprising materials derived from the nut husks of the nuts to be processed and a polyvalent metal ion containing compound.

7. The shelling processing aid of claim 6 wherein the nut husks are selected from the group comprising pecan husks, walnut husks, macadamia nut husks and almond nut husks.

8. The shelling processing aid of claim 6 wherein the nut husks are pecan husks.

9. The shelling processing aid of claim 6 wherein the polyvalent metal ion containing compound is an iron polyvalent metal ion.

10. The shelling processing aid of claim 6 wherein the polyvalent metal ion containing compound is an iron(II) polyvalent metal ion.

11. The shelling processing aid of claim 6 wherein the polyvalent metal ion containing compound is iron(II) sulfate heptahydrate.

12. The shelling processing aid of claim 6 wherein the nut husks are pecan husks and the polyvalent metal ion containing compound is iron(II) sulfate heptahydrate.

13. The shelling processing aid of claim 12 wherein the materials form the pecan husks and iron(II) sulfate heptahydrate are in a mass ratio of about 1:2 to about 1:10.

14. The shelling processing aid of claim 13 wherein the materials from the pecan husks and iron(II) sulfate heptahydrate are in a mass ratio of about 1:7.

15. The shelling processing aid of claim 14 wherein the shelling processing aid is added to water at a concentration of about 1 g/liter, forming a working solution for contrast improvement for pecans.

16. An integrated process for improving the product quality of pecan nutmeat comprising the steps of i) coating the nuts with the anti-salmonella composition of claim 3, ii) further coating the nuts with the shelling processing aid of claim 15, iii) subsequently coating the nuts with the anti-rancidity of formula of claim 5, iv) storing the nuts as needed, v), pasteurizing the nuts, and vi), shelling and optically sorting the nuts to separate nutshell from nutmeat.

17. A nut shell mordant mixture for coloring nut shells, comprising nut husks and a polyvalent metal ion mordant.
